(19) United States
(12) Patent Application Publication
(10) Pub. No.: US 2023/0350695 A1
(43) Pub. Date: Nov. 2, 2023

(54) INFORMATION PROCESSING DEVICE AND PROFILE TOOL CONTROL METHOD

(71) Applicant: Fujitsu Limited, Kawasaki-shi (JP)

(72) Inventor: Satoshi IMAMURA, Kawasaki (JP)

(73) Assignee: Fujitsu Limited, Kawasaki-shi (JP)

(21) Appl. No.: 18/172,366

(22) Filed: Feb. 22, 2023

(30) Foreign Application Priority Data
Apr. 27, 2022 (JP) 2022-073315

(51) Int. Cl. G06F 9/445

(52) U.S. Cl. CPC G06F 9/445

(57) ABSTRACT

A non-transitory computer-readable recording medium stores a program for causing a computer to execute a process, the process includes detecting activation of a first application by a predesignated first user, determining one or more first central processing unit (CPU) cores that execute one or more tools that perform profiling of the first application from among a plurality of CPU cores in response to the detection, activating the one or more tools with the determined one or more first CPU cores, associating the first application with each of the one or more activated tools, causing each of the one or more tools to perform the profiling, and outputting an execution result of the profiling.

### CROSS-REFERENCE TO RELATED APPLICATION

This application is based upon and claims the benefit of priority of the prior Japanese Patent Application No. 2022-73315, filed on Apr. 27, 2022, the entire contents of which are incorporated herein by reference.

### FIELD

The embodiment discussed herein is related to an information processing device and a profile tool control method.

### BACKGROUND

A user of an information processing system (hereinafter, also simply referred to as user) executes, for example, necessary processing by using the information processing system provided by a system provider. Then, in this case, for example, the user acquires various types of information indicating an operational status of the information processing system by using various tools (hereinafter, also referred to as profiling).

Japanese National Publication of International Patent Application No. 2016-518633, Japanese National Publication of International Patent Application No. 2015-520452, and U.S. Patent Publication No. 2020/0167258 are disclosed as related art.

### SUMMARY

According to an aspect of the embodiment, a non-transitory computer-readable recording medium stores a program for causing a computer to execute a process, the process includes detecting activation of a first application by a predesignated first user, determining one or more first central processing unit (CPU) cores that execute one or more tools that perform profiling of the first application from among a plurality of CPU cores in response to the detection, activating the one or more tools with the determined one or more first CPU cores, associating the first application with each of the one or more activated tools, causing each of the one or more tools to perform the profiling, and outputting an execution result of the profiling.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system;

FIG. 2 is a diagram illustrating a hardware configuration of an information processing device;

FIG. 3 is a diagram illustrating a specific example of a profile tool;

FIG. 4 is a diagram illustrating a function of the information processing device according to an embodiment;

FIG. 5 is a flowchart illustrating an outline of profile tool control processing according to the embodiment;

FIG. 6 is a diagram illustrating the outline of the profile tool control processing according to the embodiment;

FIG. 7 is a flowchart illustrating details of the profile tool control processing according to the embodiment;

FIG. 8 is a flowchart illustrating details of the profile tool control processing according to the embodiment;

FIG. 9 is a flowchart illustrating details of the profile tool control processing according to the embodiment;

FIG. 10 is a flowchart illustrating details of the profile tool control processing according to the embodiment;

FIG. 11 is a flowchart illustrating details of the profile tool control processing according to the embodiment;

FIG. 12 is a diagram illustrating a specific example of user information;

FIG. 13 is a diagram illustrating a specific example of result information; and

FIG. 14 is a diagram illustrating a specific example of processing in step S35.

### DESCRIPTION OF EMBODIMENT

In a case where an anomaly such as a failure (hereinafter, also simply referred to as anomaly) occurs in the information processing system as described above, for example, the user investigates a cause of the anomaly occurred in the information processing system by comparing results of profiling at a plurality of time points in the past (hereinafter, also simply referred to as profile result). In this case, for example, the user compares a profile result at a time point when the information processing system normally operates and a profile result at a time point when the anomaly has occurred in the information processing system.

However, the profiling as described above may be performed, for example, at a timing determined as necessary by the user. Therefore, in the information processing system described above, for example, there is a possibility that the profiling at the time point when the information processing system normally operates is not performed. Therefore, for example, there is a case where the user is unable to compare the profile result at the time point when the information processing system normally operates and the profile result at the time point when the anomaly has occurred in the information processing system and is unable to investigate a cause of the anomaly occurred in the information processing system.

[Configuration of Information Processing System According to Embodiment]

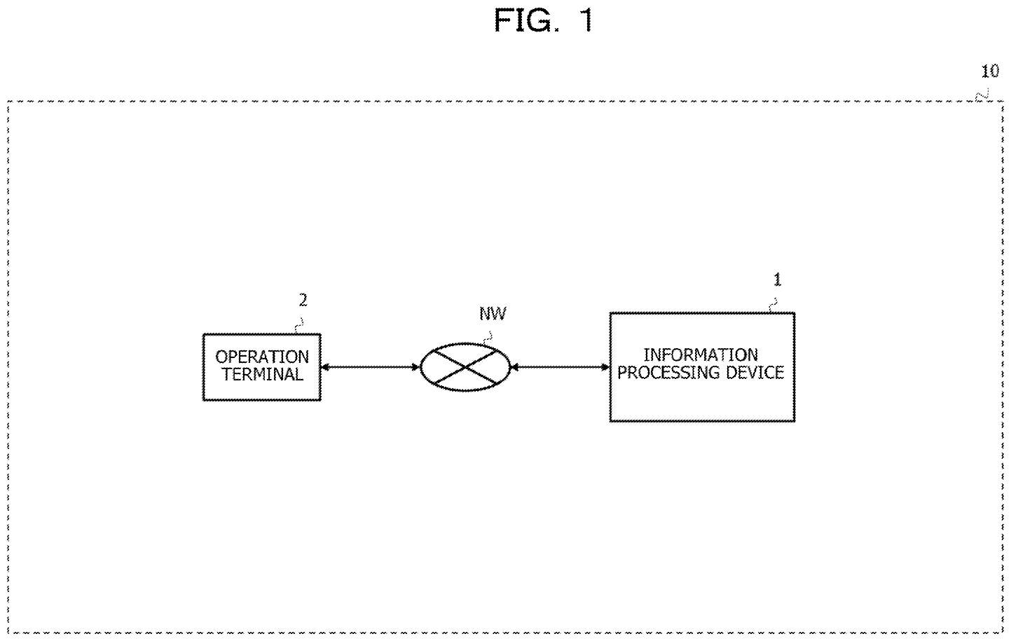

First, a configuration of an information processing system will be described. FIG. 1 is a diagram illustrating a configuration of an information processing system 10.

The information processing system 10 illustrated in FIG. 1 includes, for example, an information processing device 1 and an operation terminal 2.

The information processing device 1 is, for example, a physical machine or a virtual machine, and for example, one or more applications for executing various types of processing operate. Furthermore, in the information processing device 1, for example, one or more programs for performing profiling of the information processing device 1 during execution of each application (hereinafter, also referred to as profile tool) operate.

The operation terminal 2 is, for example, a personal computer (PC) or the like that inputs necessary information to the information processing device 1 by a user. For example, the operation terminal 2 may access the information processing device 1 via a network NW such as the Internet.

[Hardware Configuration of Information Processing Device]

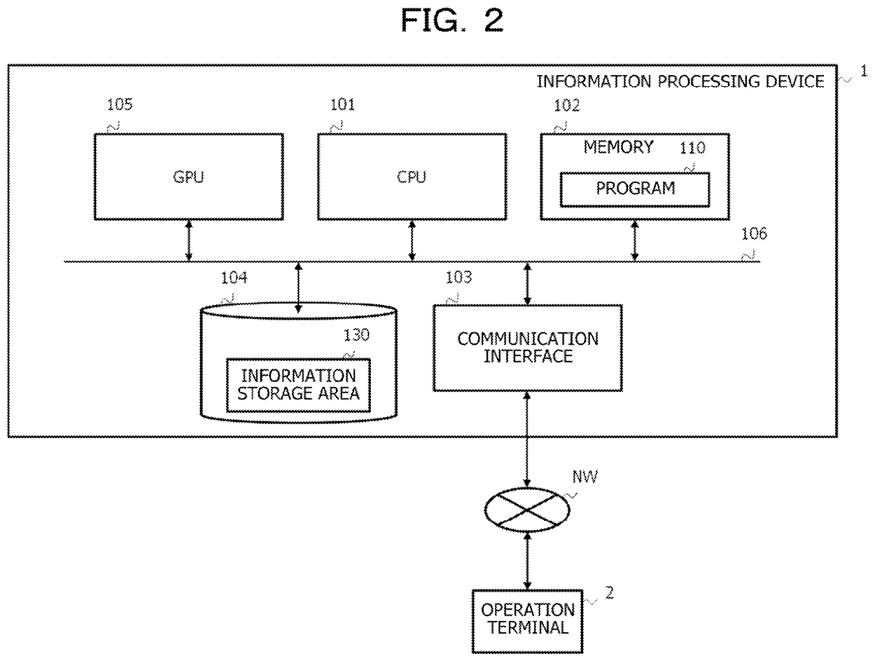

Next, a hardware configuration of the information processing device 1 will be described. FIG. 2 is a diagram illustrating the hardware configuration of the information processing device 1.

As illustrated in FIG. 2, the information processing device 1 includes, for example, a central processing unit (CPU) 101 that is a processor, a memory 102, a communication interface 103, a storage 104, and a graphics processing unit (GPU) 105. The units are coupled to each other via a bus 106.

The storage 104 includes, for example, a program storage area (not illustrated) that stores a program 110 used to execute processing for controlling activation of a profiling tool (hereinafter, also referred to as profile tool control processing or tool control processing). Furthermore, the storage 104 includes, for example, an information storage area 130 that stores information used when the profile tool control processing is executed. Note that the storage 104 may be, for example, a hard disk drive (HDD) or a solid state drive (SSD).

The CPU 101 executes, for example, the program 110 loaded from the storage 104 to the memory 102 and executes the profile tool control processing.

Furthermore, the communication interface 103 communicates with the operation terminal 2 via the network NW such as the Internet, for example.

Note that, hereinafter, a case will be described where the information processing device 1 includes the GPU 105. However, the information processing device 1 may include, for example, an accelerator such as a field programmable gate array (FPGA), instead of the GPU 105 or in addition to the GPU 105.

[Specific Example of Profile Tool]

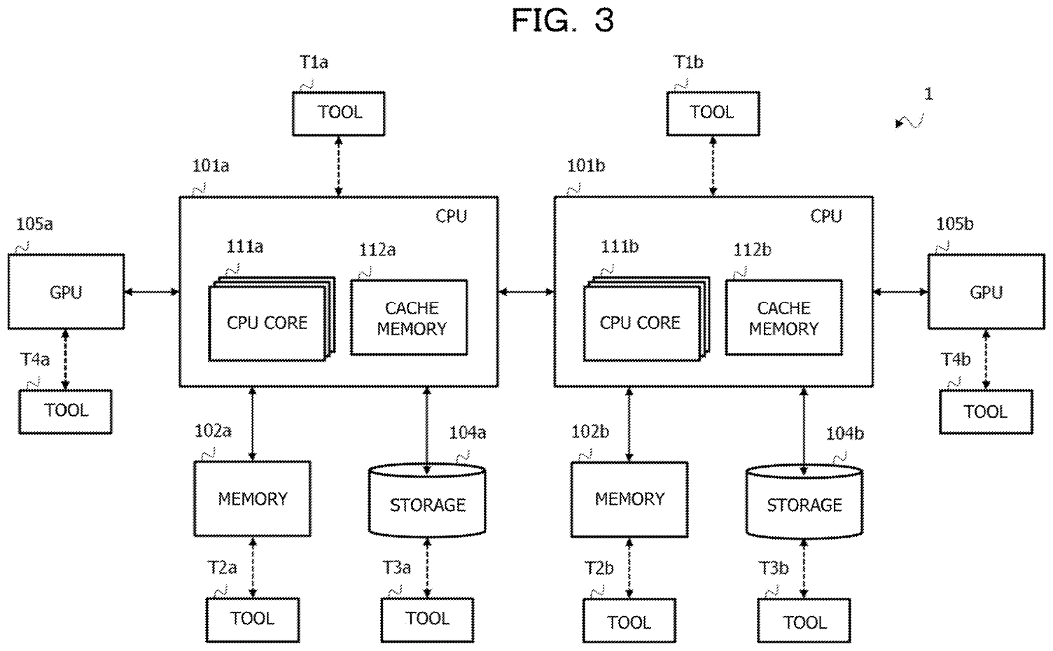

Next, a specific example of the profile tool will be described. FIG. 3 is a diagram illustrating the specific example of the profile tool. Hereinafter, as illustrated in FIG. 3, a case will be described where two CPUs 101 (hereinafter, also referred to as CPU 101a and CPU 101b), two memories 102 (hereinafter, also referred to as memory 102a and memory 102b), two storages 104 (hereinafter, also referred to as storage 104a and storage 104b), and two GPUs 105 (hereinafter, also referred to as GPU 105a and GPU 105b) are mounted on the information processing device 1. Furthermore, hereinafter, a case will be described where the CPU 101a and the CPU 101b are directly connected, the memory 102a, the storage 104a, and the GPU 105a are directly connected to the CPU 101a, and in addition, the memory 102b, the storage 104b, and the GPU 105b are directly connected to the CPU 101b as illustrated in FIG. 3.

As illustrated in FIG. 3, on the CPU 101a, for example, a plurality of CPU cores 111a and a cache memory 112a are mounted. Furthermore, on the CPU 101b, for example, a plurality of CPU cores 111b and a cache memory 112b are mounted. Hereinafter, the plurality of CPU cores 111a and the plurality of CPU cores 111b are collectively and simply referred to as a CPU core 111, and the cache memory 112a and the cache memory 112b are collectively and simply referred to as a cache memory 112.

Then, in the information processing device 1, for example, a tool T1a that performs profiling of the CPU 101a and a tool T1b that performs profiling of the CPU 101b operate.

For example, the tool T1a is a profile tool that measures, for example, an operating frequency of each of the plurality of CPU cores 111a, a usage rate of each of the plurality of CPU cores 111a, the number of occurrences of thread migration between the plurality of CPU cores 111a, or the number of occurrences of page faults in the memory 102a. Furthermore, the tool T1b is a profile tool that measures, for example, an operating frequency of each of the plurality of CPU cores 111b, a usage rate of each of the plurality of CPU cores 111b, the number of occurrences of thread migration between the plurality of CPU cores 111b, or the number of occurrences of page faults in the memory 102b.

Furthermore, in the information processing device 1, for example, a tool T2a that performs profiling of the memory 102a and a tool T2b that performs profiling of the memory 102b operate.

For example, the tool T2a is a profile tool that measures, for example, a usage of the memory 102a, a bandwidth of the memory 102a, a ratio between the number of occurrences of writing processing and the number of occurrences of reading processing in the memory 102a, or a ratio between the number of accesses to the memory 102a and the number of accesses to the memory 102b. Furthermore, the tool T2b is a profile tool that measures, for example, a usage of the memory 102b, a bandwidth of the memory 102b, a ratio between the number of occurrences of writing processing and the number of occurrences of reading processing in the memory 102b, or a ratio between the number of accesses to the memory 102b and the number of accesses to the memory 102a.

Furthermore, in the information processing device 1, for example, a tool T3a that performs profiling of the storage 104a and a tool T3b that performs profiling of the storage 104b operate.

For example, the tool T3a is a profile tool that measures, for example, a usage of the storage 104a, a latency of the storage 104a, or a bandwidth of the storage 104a. Furthermore, the tool T3b is a profile tool that measures, for example, a usage of the storage 104b, a latency of the storage 104b, or a bandwidth of the storage 104b.

Moreover, in the information processing device 1, for example, a tool T4a that performs profiling of the GPU 105a and a tool T4b that performs profiling of the GPU 105b operate.

For example, the tool T4a is a profile tool that measures, for example, an operating frequency of the GPU 105a, a temperature of the GPU 105a, or a usage rate of the GPU 105a. Furthermore, the tool T4b is a profile tool that measures, for example, an operating frequency of the GPU 105b, a temperature of the GPU 105b, or a usage rate of the GPU 105b.

Note that, hereinafter, the tool T1a, the tool T1b, the tool T2a, the tool T2b, the tool T3a, the tool T3b, the tool T4a, and the tool T4b are collectively referred to as a tool T.

Then, for example, in a case where a performance change (for example, anomaly) of an application occurs in the information processing device 1, a user investigates a cause of the performance change, for example, by comparing results of profiling at a plurality of time points in the past. In this case, for example, a user compares a profile result at a time point before the performance change of the application occurs (for example, time point when information processing device 1 normally operates) and a profile result at a time point after the performance change of the application has occurred (for example, time point when anomaly has occurred in information processing device 1).

However, the profiling as described above may be performed, for example, at a timing determined as necessary by the user. Therefore, in the information processing device 1 described above, for example, there is a possibility that the profiling at the time point when the information processing device 1 normally operates is not performed. Therefore, for example, there is a case where the user is unable to compare the profile result at the time point when the information processing device 1 normally operates and the profile result at the time point when the anomaly has occurred in the information processing device 1 and is unable to investigate the cause of the anomaly occurred in the information processing device 1.

Therefore, the information processing device 1 according to the present embodiment, for example, determines one or more CPU cores 111 (hereinafter, also referred to as tool execution core 111 or first CPU core 111) that execute one or more tools T for performing profiling of a target application from among the plurality of CPU cores 111, in response to detection such that an application (hereinafter, also referred to as target application or first application) is activated by a predetermined user (hereinafter, also referred to as target user or first user).

Then, for example, the information processing device 1 activates the one or more tools T with the one or more determined tool execution cores 111. Thereafter, for example, the information processing device 1 associates the target application with each of the one or more activated tools T, causes each of the one or more tools T to perform the profiling of the target application (for example, profiling of CPU 101, memory 102, or the like at the time when target application is activated), and further outputs a profiling execution result regarding the information processing device 1.

For example, the information processing device 1 according to the present embodiment activates the one or more tools T using the activation of the target application performed by the predesignated target user as a trigger and performs the profiling of the target application.

As a result, the information processing device 1 according to the present embodiment may, for example, automatically perform profiling at an appropriate timing. For example, the information processing device 1 may automatically perform profiling at the time when the target application is executed. Therefore, for example, the information processing device 1 may automatically acquire the profile result that may be referred at the time when an anomaly occurs.

[Function of Information Processing Device According to Embodiment]

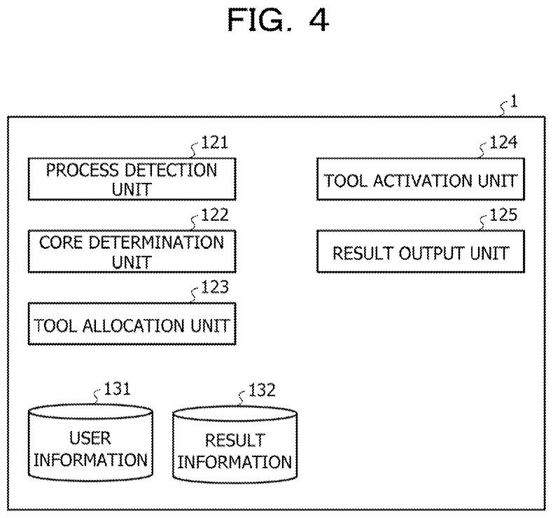

Next, a function of the information processing device 1 according to the embodiment will be described. FIG. 4 is a diagram illustrating the function of the information processing device 1 according to the embodiment.

As illustrated in FIG. 4, for example, the information processing device 1 implements various functions including a process detection unit 121, a core determination unit 122, a tool allocation unit 123, a tool activation unit 124, and a result output unit 125 through organic cooperation of hardware such as the CPU 101 (CPU core 111) or the memory 102 with the program 110.

Furthermore, as illustrated in FIG. 4, the information processing device 1 stores, for example, user information 131 and result information 132 in the information storage area 130.

For example, the process detection unit 121 detects activation of the target application in the CPU core 111. Furthermore, for example, the process detection unit 121 detects stop of the target application in the CPU core 111.

For example, the process detection unit 121 identifies a new user (hereinafter, also referred to as second user) who activates a new application (hereinafter, also referred to as second application) in response to detection such that the new application is activated. Then, for example, the process detection unit 121 refers to the user information 131 stored in the information storage area 130. In a case of determining that the new user matches the target user, the process detection unit 121 determines that the new application is the target application. The user information 131 is, for example, information used to identify the target user. Note that the target user may be, for example, a predetermined user or may be a user who has started execution of the profile tool control processing in the information processing device 1.

For example, the core determination unit 122 determines the one or more tool execution cores 111 that execute the one or more tools T for performing the profiling of the target application from among the plurality of CPU cores 111 in response to detection by the process detection unit 121 such that the target application is activated.

For example, in a case where the core determination unit 122 determines a plurality of tool execution cores 111, the tool allocation unit 113 determines CPU cores 111 that each activates any of the one or more tools T.

For example, the tool activation unit 114 activates each of the one or more tools T with the one or more tool execution cores 111 determined by the core determination unit 122. Thereafter, for example, the tool activation unit 114 associates the target application with each of the one or more activated tools T and causes each of the one or more tools T to perform the profiling of the target application.

The result output unit 125 outputs, for example, the result information 132 indicating a result of profiling performed during the execution of the target application (between activation to stop of target application). For example, the result output unit 125 accumulates the result information 132 in the storage 104. Furthermore, the result output unit 125 outputs, for example, the result information 132 to the operation terminal 2.

[Outline of Profile Tool Control Processing According to Embodiment]

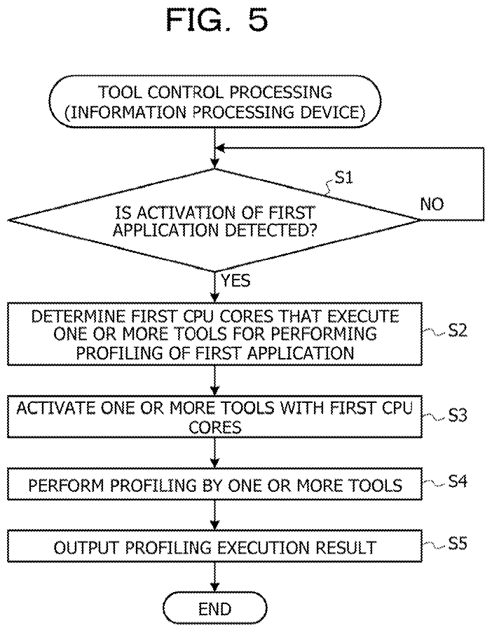

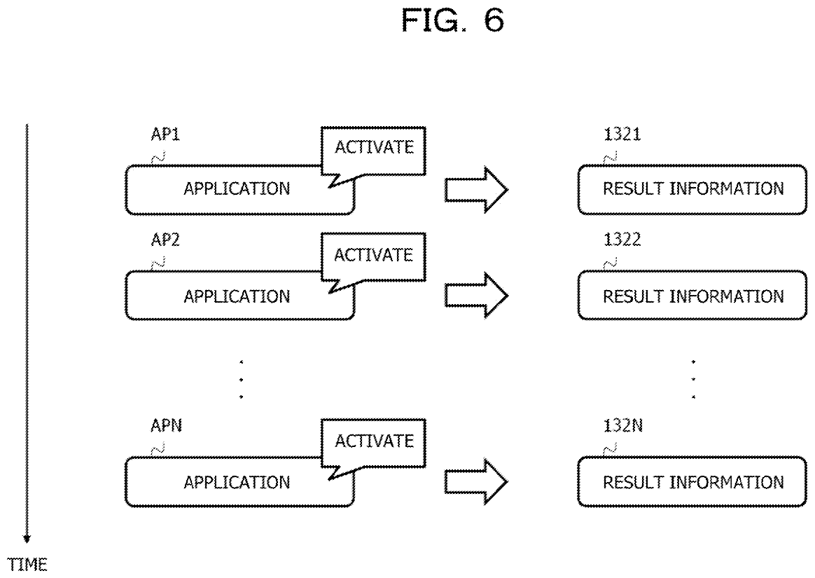

Next, an outline of the embodiment will be described. FIG. 5 is a flowchart illustrating the outline of the profile tool control processing according to the embodiment. Furthermore, FIG. 6 is a diagram illustrating the outline of the profile tool control processing according to the embodiment.

As illustrated in FIG. 5, for example, the information processing device 1 waits for detection of activation of the target application performed by the target user (NO in step S1).

Then, in a case where the activation of the target application performed by the target user is detected (YES in step S1), for example, the information processing device 1 determines one or more tool execution cores 111 that execute one or more tools T for performing the profiling of the target application from among the plurality of CPU cores 111 (step S2).

Subsequently, for example, the information processing device 1 activates each of the one or more tools T with the one or more tool execution cores 111 determined in step S2 (step S3).

Moreover, for example, the information processing device 1 associates the target application with each of the one or more tools T activated in step S3 and causes each of the one or more tools T to perform the profiling of the target application (step S4).

Then, for example, the information processing device 1 outputs a profiling execution result derived in step S4 (step S5).

For example, each time when the target application is activated by the target user, the information processing device 1 activates each of the one or more tools T with the CPU core 111 (tool execution core 111) that may be determined not to hinder execution of each application, and causes the one or more tools T to perform the profiling of the target application.

For example, as illustrated in FIG. 6, in a case of detecting activation of each of a plurality of applications (applications AP1, AP2, . . . , and APN in FIG. 6) in the processing in step S1, the information processing device 1 performs profiling of each application at each activation timing of the plurality of applications. Then, for example, the information processing device 1 generates and outputs each piece of the result information 132 (result information 1321, result information 1322, . . . , and result information 132N in FIG. 6) that is an aggregation result of the profiling performed during the execution of each application (between activation and stop of each application), for each of the plurality of applications.

As a result, the information processing device 1 according to the present embodiment may, for example, automatically perform profiling at an appropriate timing. For example, the information processing device 1 may automatically perform profiling at the time when the target application is executed. Therefore, for example, the information processing device 1 may automatically acquire the profile result that may be referred at the time when an anomaly occurs.

Therefore, for example, the information processing device 1 according to the present embodiment may prevent occurrence of omission of the profiling or the like caused by intentionally performing the profiling of the target application by a user. Furthermore, for example, the information processing device 1 may reduce a workload of the user associated with the execution of the profiling.

[Details of Profile Tool Control Processing According to Embodiment]

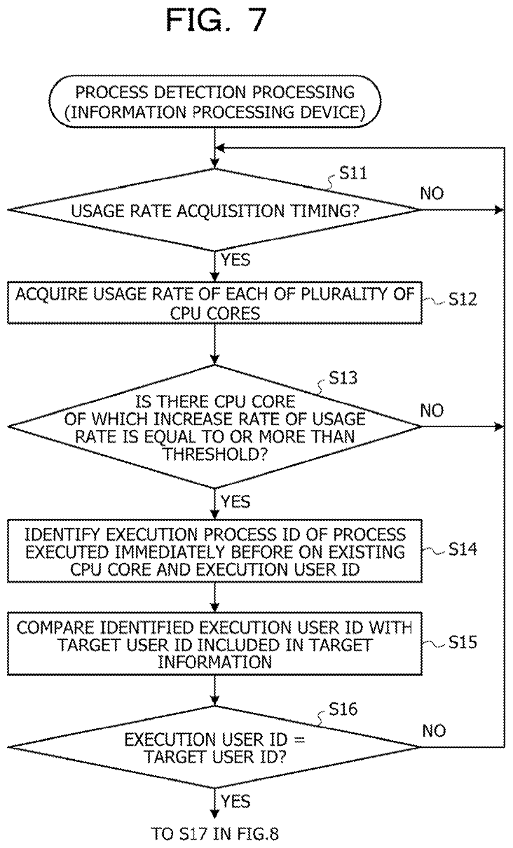

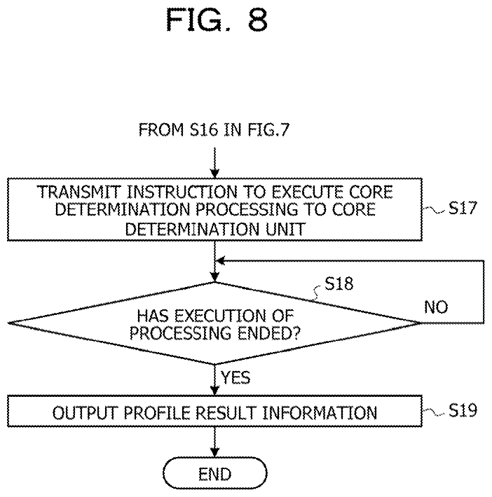

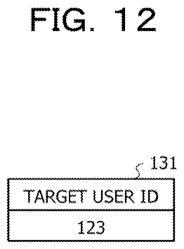

Next, details of the embodiment will be described. FIGS. 7 to 11 are flowcharts illustrating details of the profile tool control processing according to the embodiment. Furthermore, FIGS. 12 to 14 are diagrams illustrating the details of the profile tool control processing according to the embodiment.

[Process Detection Processing]

First, in the profile tool control processing according to the embodiment, processing for detecting activation of the target application by the target user (hereinafter, also referred to as process detection processing) will be described. Note that, hereinafter, an application being executed in the information processing device 1 is also referred to as a process.

As illustrated in FIG. 7, for example, the process detection unit 121 waits for a usage rate acquisition timing (NO in step S11). For example, the usage rate acquisition timing may be a periodic timing such as an interval of several seconds.

Then, in a case where the usage rate acquisition timing comes (YES in step S11), the process detection unit 121 acquires, for example, a CPU usage rate of each of the plurality of CPU cores 111 (step S12).

Subsequently, for example, the process detection unit 121 determines whether or not there is a CPU core 111 of which an increase of the CPU usage rate acquired in the processing in step S12 is equal to or more than a predetermined threshold, from among the plurality of CPU cores 111 (step S13).

For example, the process detection unit 121 calculates the increase of the CPU usage rate by subtracting the CPU usage rate acquired in the processing in step S12 at previous time from the CPU usage rate acquired in the processing in step S12 at this time, for each of the plurality of CPU cores 111. For example, the process detection unit 121 calculates the increase of the CPU usage rate within a time from an execution timing of the processing in step S12 at previous time to an execution timing of the processing in step S12 at this time (hereinafter, also referred to as predetermined time), for each of the plurality of CPU cores 111. Then, for example, the process detection unit 121 determines whether or not there is a CPU core 111 of which the usage rate of the CPU after the increase exceeds the predetermined threshold.

For example, the process detection unit 121 determines that a new application is activated, with the CPU core 111 of which the increase of the CPU usage rate within the predetermined time exceeds the threshold.

As a result, in a case of determining that there is no CPU core 111 of which the increase of CPU usage rate is equal to or more than the threshold (No in step S13), the process detection unit 121 executes the processing in and after step S11 again, for example.

For example, in this case, the process detection unit 121 determines that the target application is not activated within the predetermined time and executes the processing in and after step S11 again.

On the other hand, in a case of determining that there are one or more CPU cores 111 of which the increase of CPU usage rate is equal to or more than the threshold (NO in step S13), for example, the process detection unit 121 identifies a process identifier (ID) of a process of which execution has been started immediately before (hereinafter, also referred to as execution process ID) and an identification ID of a user who executes the process of which the execution has been started immediately before (hereinafter, also referred to as execution user ID), with each of the one or more CPU cores 111 determined to exist in the processing in step S13 (step S14).

Then, for example, the process detection unit 121 refers to the user information 131 stored in the information storage area 130 and compares the execution user ID identified in the processing in step S14 and a target user ID of which information is included in the user information 131 (step S15). The target user ID is, for example, an identification ID of the target user. Hereinafter, a specific example of the user information 131 will be described.

[Specific Example of User Information]

FIG. 12 is a diagram illustrating the specific example of the user information 131.

As illustrated in FIG. 12, the user information 131 includes, for example, a “target user ID” used to identify the target user. For example, in the user information 131 illustrated in FIG. 12, “123” is set as the “target user ID”.

Returning to FIG. 7, in a case of determining that a target user ID that matches the execution user ID identified in the processing in step S14 is not included in the user information 131 (NO in step S16), the process detection unit 121 executes the processing in and after step S11 again.

For example, in this case, the process detection unit 121 determines that the target application is not activated within the predetermined time and executes the processing in and after step S11 again.

On the other hand, in a case of determining that the target user ID that matches the execution user ID identified in the processing in step S14 is included in the user information 131 (YES in step S16), the process detection unit 121, for example, transmits an instruction to execute core determination processing to the core determination unit 122 (step S17).

In this case, for example, the process detection unit 121 determines that the target application is activated within the predetermined time and instructs the core determination unit 122 to execute the core determination processing. In this case, for example, the process detection unit 121 determines that a current timing is a timing when the profiling of the target application is started, and instructs the core determination unit 122 to execute the core determination processing.

Thereafter, for example, the process detection unit 121 waits for detection of the stop of the process corresponding to the target application (hereinafter, also referred to as target process) (NO in step S18).

For example, the process detection unit 121 waits for an end timing of the profiling of the target application.

As a result, in a case where the stop of the target process is detected (YES in step S18), for example, the result output unit 125 outputs the result information 132 of the profiling of the target application (step S19).

For example, the result output unit 125 aggregates results of one or more times of profiling performed by each of the one or more tools T during the execution of the target application (between activation and stop of target application) and generates the result information 132. Then, for example, the result output unit 125 outputs the generated result information 132 to the operation terminal 2. Hereinafter, a specific example of the result information 132 will be described.

[Specific Example of Result Information]

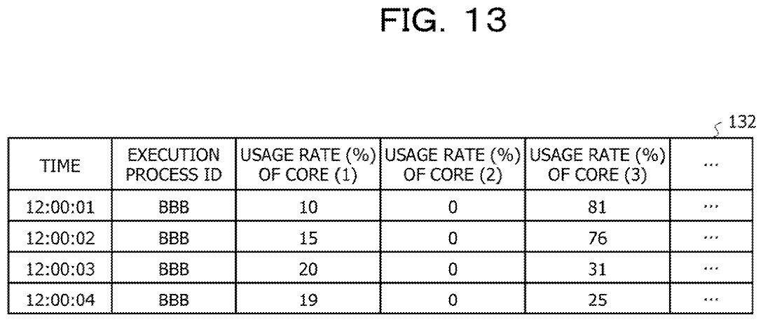

FIG. 13 is a diagram illustrating the specific example of the result information 132. Hereinafter, a specific example of the result information 132 generated from a result of profiling performed by the tool T1a during execution of a process of which an “execution process ID” is “BBB” will be described.

As illustrated in FIG. 13, for example, the result information 132 includes a “time” to which an execution time of profiling is set, an “execution process ID” to which the execution process ID is set, and a “usage rate of a core (1)” to which a usage rate of a first core (hereinafter, also referred to as core (1)) among the plurality of CPU cores 111 is set. Furthermore, for example, the result information 132 includes a “usage rate of a core (2)” to which a usage rate of a second core (hereinafter, also referred to as core (2)) among the plurality of CPU cores 111 is set and a “usage rate of a core (3)” to which a usage rate of a third core (hereinafter, also referred to as core (3)) among the plurality of CPU cores 111 is set.

For example, in the result information 132 illustrated in FIG. 13, in information in the first row, “12:00:01” is set as the “time”, “BBB” is set as the “execution process ID”, “10 (%)” is set as the “usage rate of the core (1)”, “0 (%)” is set as the “usage rate of the core (2)”, and “81 (%)” is set as the “usage rate of the core (3).

Furthermore, for example, in the result information 132 illustrated in FIG. 13, in information in the second row, “12:00:02” is set as the “time”, “BBB” is set as the “execution process ID”, “15 (%)” is set as the “usage rate of the core (1)”, “0 (%)” is set as the “usage rate of the core (2)”, and “76 (%)” is set as the “usage rate of the core (3).

Furthermore, for example, in the result information 132 illustrated in FIG. 13, in information in the third row, “12:00:03” is set as the “time”, “BBB” is set as the “execution process ID”, “20 (%)” is set as the “usage rate of the core (1)”, “0 (%)” is set as the “usage rate of the core (2)”, and “31 (%)” is set as the “usage rate of the core (3).

Moreover, for example, in the result information 132 illustrated in FIG. 13, in information in the fourth row, “12:00:04” is set as the “time”, “BBB” is set as the “execution process ID”, “19 (%)” is set as the “usage rate of the core (1)”, “0 (%)” is set as the “usage rate of the core (2)”, and “25 (%)” is set as the “usage rate of the core (3).

Note that the result output unit 125 may collectively output the result information 132 generated from each of the plurality of tools T, for example, in the processing in step S19.

[Core Determination Processing]

Next, processing for determining the tool execution cores 111 on which each tool T operates (hereinafter, also referred to as core determination processing) in the profile tool control processing according to the embodiment will be described.

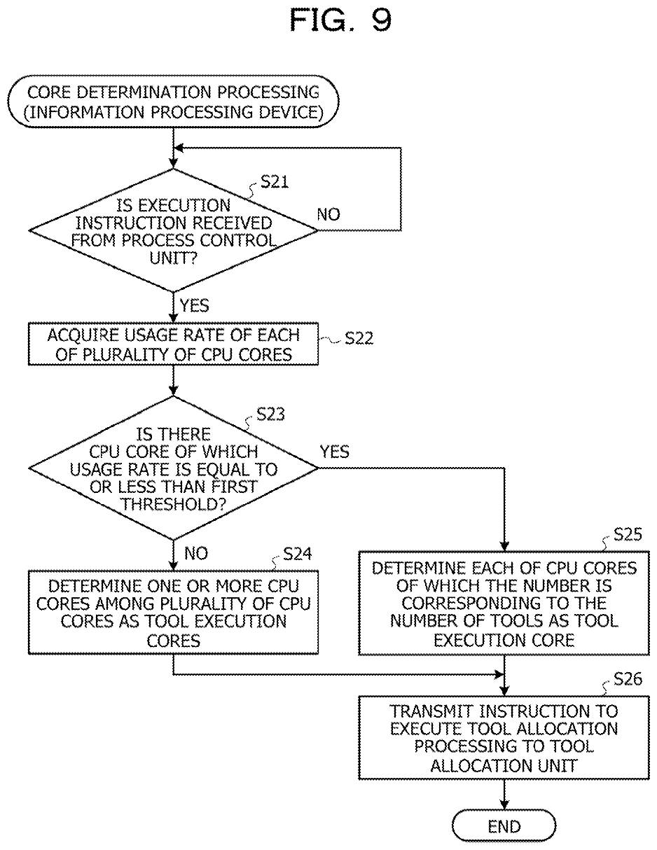

As illustrated in FIG. 9, for example, the core determination unit 122 waits for reception of the instruction to execute the core determination processing from the process detection unit 121 (NO in step S21).

Then, in a case of receiving the instruction to execute the core determination processing from the process detection unit 121 (YES in step S21), for example, the core determination unit 122 acquires the CPU usage rate of each of the plurality of CPU cores 111 (step S22).

Subsequently, for example, the core determination unit 122 determines whether or not there is a CPU core 111 of which the CPU usage rate acquired in the processing in step S22 is equal to or less than a predetermined threshold (hereinafter, also referred to as first threshold), from among the plurality of CPU cores 111 (step S23).

Note that the first threshold may be, for example, zero (%). For example, the core determination unit 122 may determine whether or not there is a CPU core 111 of which the CPU usage rate acquired in the processing in step S22 is zero (%).

As a result, in a case of determining that there is a CPU core 111 of which the CPU usage rate acquired in the processing in step S22 is equal to or less than the first threshold (YES in step S23), for example, the core determination unit 122 determines CPU cores 111 of which the number is corresponding to the number of tools T (the number of tools T for performing profiling of target application) as the tool execution cores 111 for executing the tools T (step S25).

For example, in a case where the number of CPU cores 111 determined to exist in the processing in step S23 is equal to or more than the number of tools T, for example, the core determination unit 122 determines the CPU cores 111 as many as the number of tools T as the tool execution cores 111.

For example, by determining that a CPU core 111 of which the CPU usage rate is equal to or less than the first threshold as the tool execution core 111, even in a case where the plurality of tools T is executed at the same time, the information processing device 1 may prevent performance inhibition of each application being executed in the information processing device 1.

Furthermore, for example, by determining CPU cores 111 as many as the number of tools T as the tool execution cores 111, for example, the information processing device 1 may operate the plurality of tools T respectively on the tool execution cores 111 different from each other. Therefore, for example, the information processing device 1 may prevent occurrence of an interference between the plurality of tools T.

On the other hand, in a case where the number of CPU cores 111 determined to exist in the processing in step S23 is less than the number of tools T, for example, the core determination unit 122 determines all the CPU cores 111 determined to exist in the processing in step S23 as the tool execution cores 111.

Thereafter, for example, the core determination unit 122 transmits an instruction to execute tool allocation processing to the tool allocation unit 123 (step S26).

Furthermore, in a case of determining that there is no CPU core 111 of which the CPU usage rate acquired in the processing in step S22 is equal to or less than the first threshold (NO in step S23), for example, the core determination unit 122 determines one or more CPU cores 111 among the plurality of CPU cores 111 (for example, one CPU core 111) as the tool execution cores 111 (step S24). Then, even in this case, for example, the core determination unit 122 transmits the instruction to execute the tool allocation processing to the tool allocation unit 123 (step S26).

For example, in this case, the core determination unit 122 may determine a CPU core 111 of which the CPU usage rate exceeds the first threshold (for example, CPU core 111 that is highly likely to execute application) and is equal to or less than a second threshold (threshold larger than first threshold) as the tool execution core 111.

Furthermore, in this case, for example, the core determination unit 122 may determine a predetermined number of CPU cores 111 in descending order of the CPU usage rate, from among the plurality of CPU cores 111, as the tool execution cores 111.

Moreover, in this case, for example, the core determination unit 122 may determine a CPU core 111 (one CPU core 111) with the lowest CPU usage rate, from among the plurality of CPU cores 111, as the tool execution core 111.

As a result, for example, even in a case where the CPU core 111 of which the CPU usage rate exceeds the first threshold is used as the tool execution core 111, the information processing device 1 may prevent the performance inhibition of each application being executed in the information processing device 1.

[Tool Allocation Processing]

Next, processing for allocating each tool T to the tool execution core 111 (hereinafter, also referred to as tool allocation processing) in the profile tool control processing according to the embodiment will be described.

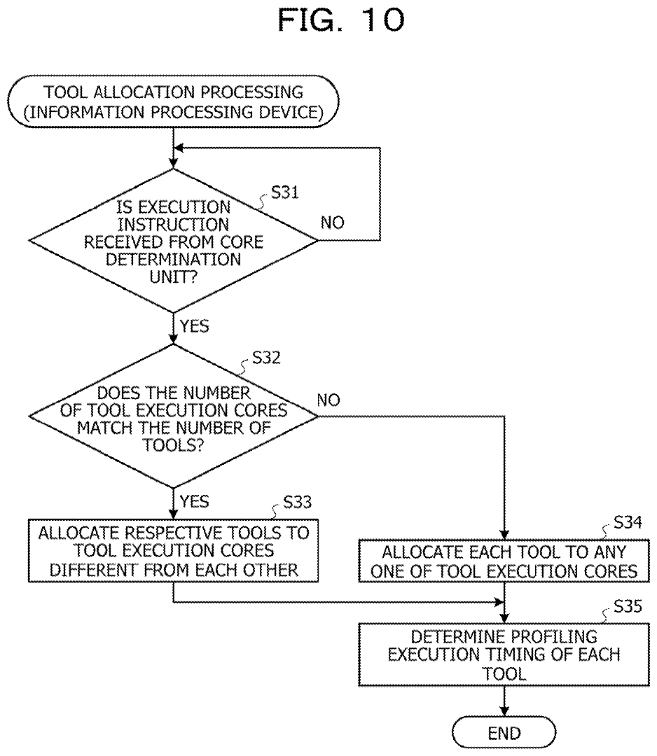

As illustrated in FIG. 10, for example, the tool allocation unit 123 waits for reception of the instruction to execute the tool allocation processing from the core determination unit 122 (NO in step S31).

Then, in a case of receiving the instruction to execute the tool allocation processing from the core determination unit 122 (YES in step S31), for example, the tool allocation unit 123 determines whether or not the number of tools T (the number of tools T for performing profiling of target application) and the number of tool execution cores 111 determined in the processing in step S24 or step S25 match (step S32).

As a result, in a case of determining that the number of tools T matches the number of tool execution cores 111 (YES in step S32), for example, the tool allocation unit 123 respectively allocates the tools T to the tool execution cores 111 different from each other (step S33).

On the other hand, in a case of determining that the number of tools T does not match the number of tool execution cores 111, for example, in a case where the number of tool execution cores 111 is less than the number of tools T (NO in step S32), for example, the tool allocation unit 123 allocates each tool T to any one of the tool execution cores 111 (step S34).

For example, in this case, the tool allocation unit 123 may allocate each tool T to any one of the tool execution cores 111 so that the numbers of tools T allocated to the respective tool execution cores 111 are equal as possible.

Then, for example, after step S33 or step S34, the tool allocation unit 123 determines an execution timing of profiling by each tool T (step S35). Hereinafter, a specific example of the processing in step S35 will be described.

[Specific Example of Processing in Step S35]

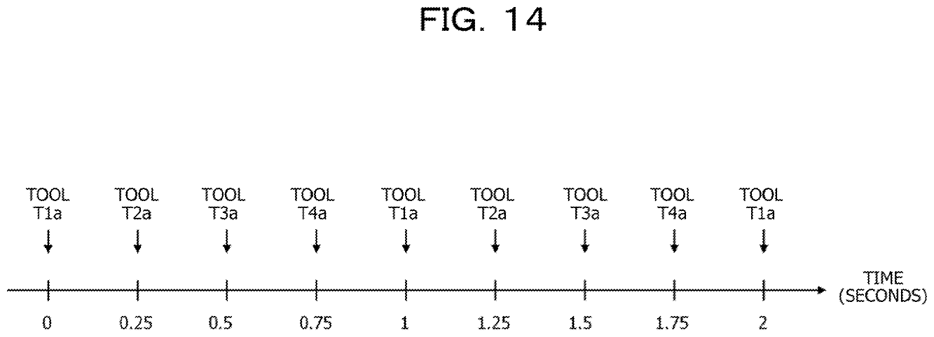

FIG. 14 is a diagram illustrating the specific example of the processing in step S35.

For example, in a case where the plurality of tools T needs to be executed by a single tool execution core 111, the tool allocation unit 123 determines an execution timing of each tool T so that execution times of profiling by the respective tools T do not overlap.

For example, in this case, the tool allocation unit 123 determines an execution timing of each tool T so that execution intervals of two tools T that are consecutively executed are equal to each other.

For example, in a case where the single tool execution core 111 executes the tool T1a, the tool T2a, the tool T3a, and the tool T4a and in a case where each tool T is executed once (times) per second (second), the tool allocation unit 123, for example, calculates 0.25 (seconds) by dividing one (second) by four that is the number of tools. Then, for example, the tool allocation unit 123 determines the execution timing of each tool T so that the execution intervals of the two tools T that are consecutively executed become 0.25 (seconds) and the tool T1a, the tool T2a, the tool T3a, and the tool T4a are repeatedly executed in this order.

In this case, for example, as illustrated in FIG. 14, the tool allocation unit 123 determines a first execution time of the tool T1a as zero (seconds), determines a first execution time of the tool T2a as 0.25 (seconds), determines a first execution time of the tool T3a as 0.5 (seconds), and determines a first execution time of the tool T4a as 0.75 (seconds). Furthermore, in this case, for example, the tool allocation unit 123 determines a second execution time of the tool T1a as one (second), determines a second execution time of the tool T2a as 1.25 (seconds), determines a second execution time of the tool T3a as 1.5 (seconds), and determines a second execution time of the tool T4a as 1.75 (seconds).

As a result, for example, even in a case where the plurality of tools T is executed by the single tool execution core 111, the information processing device 1 may reduce a possibility that an interference occurs between the plurality of tools T.

Note that, in a case where only one tool T is executed by the single tool execution core 111, an interference between the plurality of tools T does not occur in each tool execution core 111. Therefore, in this case, for example, the tool allocation unit 123 may determine the execution timing of each of the plurality of tools T without performing adjustment with other tools T as described above.

[Tool Activation Processing]

Next, processing for activating the tool T (hereinafter, also referred to as tool activation processing) in the profile tool control processing according to the embodiment will be described.

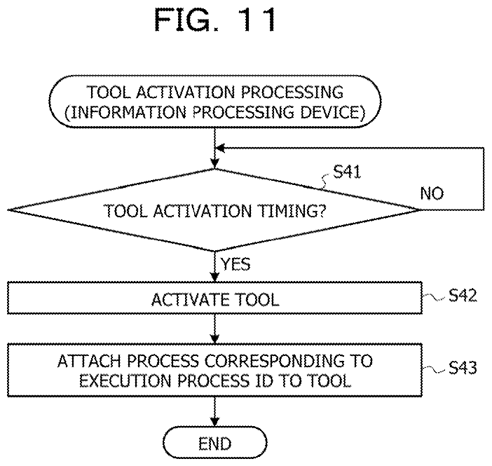

As illustrated in FIG. 11, for example, the tool activation unit 124 waits for a tool activation timing of any one of the tools T (NO in step S41). The tool activation timing is, for example, the execution timing of profiling determined in the processing in S35. For example, the tool activation timing in the example described with reference to FIG. 14 is a timing at every 0.25 seconds.

Then, in a case where the tool activation timing of any one of the tools T comes (YES in step S41), for example, the tool activation unit 124 activates the tool T of which the tool activation timing comes (step S42).

For example, as illustrated in FIG. 14, the tool activation unit 124 activates the tool T1a at the tool activation timing of a time point of zero seconds and activates the tool T2a at the tool activation timing of a time point of 0.25 seconds.

Moreover, in this case, for example, the tool activation unit 124 attaches the target process to the tool T activated in the processing in S42 (step S43). Then, the tool T activated in the processing in step S42 starts, for example, the profiling of the target application attached in the processing in step S43.

For example, in a case where the tool T activated in the processing in step S42 is the tool T1a, for example, the tool T1a performs profiling of the CPU core 111a (one of CPU cores 111a) on which the target process operates.

Furthermore, in a case where the tool T activated in the processing in step S42 is the tool T2a, for example, the tool T2a performs profiling of the memory 102 (for example, memory 102a) accessed by the CPU core 111a on which the target process operates.

Furthermore, in a case where the tool T activated in the processing in step S42 is the tool T3a, for example, the tool T3a performs profiling of the storage 104 (for example, storage 104a) accessed by the CPU core 111a on which the target process operates.

Furthermore, in a case where the tool T activated in the processing in step S42 is the tool T4a, for example, the tool T4a performs profiling of the GPU 105 (for example, GPU 105a) accessed by the CPU core 111a on which the target process operates.

In this way, for example, the information processing device 1 according to the present embodiment determines the tool execution core 111 that executes the one or more tools T for performing the profiling of the target application from among the plurality of CPU cores 111, in response to detection of the activation of the target application by the target user.

Then, for example, the information processing device 1 activates the one or more tools T with the one or more determined tool execution cores 111. Thereafter, for example, the information processing device 1 associates the target application with each of the one or more activated tools T, causes each of the one or more tools T to perform the profiling of the information processing device 1, and in addition, outputs a profiling execution result regarding the information processing device 1.

For example, the information processing device 1 according to the present embodiment activates the one or more tools T using the activation of the target application performed by the predesignated target user as a trigger and performs the profiling of the target application.

As a result, the information processing device 1 according to the present embodiment may, for example, automatically perform profiling at an appropriate timing. For example, the information processing device 1 may automatically perform profiling at the time when the target application is executed. Therefore, for example, the information processing device 1 may automatically acquire the profile result that may be referred at the time when an anomaly occurs.

Note that, in the example described above, a case has been described where the profile tool control processing is performed in the information processing device 1. However, the present embodiment is not limited to this. The profile tool control processing may be operated, for example, in an information processing device other than the information processing device 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
detecting activation of a first application by a predesignated first user;
determining one or more first central processing unit (CPU) cores that execute one or more tools that perform profiling of the first application from among a plurality of CPU cores in response to the detection;
activating the one or more tools with the determined one or more first CPU cores;
associating the first application with each of the one or more activated tools;
causing each of the one or more tools to perform the profiling; and
outputting an execution result of the profiling.

2. The non-transitory computer-readable recording medium according to claim 1, the process further comprising:
identifying, in response to detection of activation of a second application, a second user who has activated the second application; and
in a case where the identified second user matches the predesignated first user, determining that the second application is the first application.

3. The non-transitory computer-readable recording medium according to claim 2, the process further comprising:
detecting that an increase of a usage rate of any one of the plurality of CPU cores within a predetermined time is equal to or more than a threshold; and
determining, based on the increase, that the second application is activated in the any one of the plurality of CPU cores.

4. The non-transitory computer-readable recording medium according to claim 1, the process further comprising:
identifying a usage rate of each of the plurality of CPU cores;
determining, based on the identified usage rate, that the plurality of CPU cores include one or more second CPU cores a CPU core of which the usage rate is equal to or less than a first threshold; and
determining the CPU core as the one or more first CPU cores because the identified usage rate is equal to or less than the first threshold.

5. The non-transitory computer-readable recording medium according to claim 4, the process further comprising:
determining that the plurality of CPU cores include more than one second CPU cores of which the usage rate is equal to or less than the first threshold;
determining the more than one second CPU cores as the one or more first CPU cores; and
activating each of the one or more tools with any one of the first CPU cores.

6. The non-transitory computer-readable recording medium according to claim 5, the process further comprising:
in a case where a number of the more than one second CPU cores is equal to or more than a number of the one or more tools, determining CPU cores as many as the number of the one or more tools as the one or more first CPU cores from among the more than one second CPU cores; and
activating the respective one or more tools with the first CPU cores different from each other.

7. The non-transitory computer-readable recording medium according to claim 4, the process further comprising:
determining that the plurality of CPU cores does not include any CPU cores of which the usage rate is equal to or less than a first threshold; and
determining one or more CPU cores of which the usage rate is equal to or less than a second threshold larger than the first threshold as the one or more first CPU cores.

8. The non-transitory computer-readable recording medium according to claim 1, the process further comprising:
causing each of the one or more tools to perform the profiling at timing different from each other.

9. An information processing device, comprising:
a memory; and
a processor coupled to the memory and the processor configured to:
detect activation of a first application by a predesignated first user;
determine one or more first central processing unit (CPU) cores that execute one or more tools that perform profiling of a first application from among a plurality of CPU cores in response to the detection;
activate the one or more tools with the determined one or more first CPU cores;
associate the first application with each of the one or more activated tools;
cause each of the one or more tools to perform the profiling; and
output an execution result of the profiling.

10. The information processing device according to claim 9, wherein
the processor is further configured to:
identify, in response to detection of activation of a second application, a second user who has activated the second application; and
in a case where the identified second user matches the predesignated first user, determine that the second application is the first application.

11. The information processing device according to claim 10, wherein
the processor is further configured to:
detect that an increase of a usage rate of any one of the plurality of CPU cores within a predetermined time is equal to or more than a threshold; and
determine, based on the increase, that the second application is activated in the any one of the plurality of CPU cores.

12. A profile tool control method, comprising:
detecting, by a computer, activation of a first application by a predesignated first user;
determining one or more first central processing unit (CPU) cores that execute one or more tools that perform profiling of a first application from among a plurality of CPU cores in response to the detection;
activating the one or more tools with the determined one or more first CPU cores;
associating the first application with each of the one or more activated tools;
causing each of the one or more tools to perform the profiling; and
outputting an execution result of the profiling.

13. The profile tool control method according to claim 12, further comprising:
identifying, in response to detection of activation of a second application, a second user who has activated the second application; and
in a case where the identified second user matches the predesignated first user, determining that the second application is the first application.

14. The profile tool control method according to claim 13, further comprising:
detecting that an increase of a usage rate of any one of the plurality of CPU cores within a predetermined time is equal to or more than a threshold; and
determining, based on the increased, that the second application is activated in the any one of the plurality of CPU cores.

15. The non-transitory computer-readable recording medium according to claim 1, wherein the profiling is automatically triggered by the detection of activation of the first application by the predesignated first user.

16. The non-transitory computer-readable recording medium according to claim 1, wherein the profiling is performed to prevent occurrence of omission of the profiling caused by intentionally performing the profiling of a target application by a user.

17. The non-transitory computer-readable recording medium according to claim 1, the process further comprising:
automatically acquiring the execution result of the profiling for analysis when an anomaly occurs.
